(19) United States
(12) Patent Application Publication
(10) Pub. No.: US 2013/0346337 A1
(43) Pub. Date: Dec. 26, 2013

(54) Systems and Methods For Delivering Media Messages

(71) Applicant: Lets Gift it LLC, Independence, OH (US)

(72) Inventors: Ryan O'Donnell, Lakewood, OH (US); Marco DiDomenico, Cuyahoga Falls, OH (US)

(21) Appl. No.: 13/927,791

(22) Filed: Jun. 26, 2013

Related U.S. Application Data
(60) Provisional application No. 61/664,190, filed on Jun. 26, 2012.

(51) Int. Cl. G06Q 10/08

(52) U.S. Cl. CPC G06Q 10/0833
USPC 705/333

(57) ABSTRACT

A method includes providing a user interface to a sender of a gift via an electronic display. The user interface configured to allow the sender to create a media message. The method further includes storing the media message in a database; associating the media message with a shipping status of the gift; verifying that the gift was delivered to a recipient of the gift; and delivering the media message to the recipient upon verification that the gift was delivered to the recipient.

### CROSS-REFERENCE TO RELATED APPLICATIONS

This application claims the benefit of U.S. Provisional Patent Application No. 61/664,190 filed Jun. 26, 2012 entitled “Systems and Methods For Delivering Media Messages”, which is incorporated by reference herein in its entirety.

### BACKGROUND OF THE INVENTION

The present invention generally relates to systems and methods for delivering media messages. In some embodiments, the invention relates to systems and methods for delivering media messages in connection with the purchase of goods and services.

### BRIEF SUMMARY OF THE INVENTION

In one embodiment there is method comprising: providing a user interface to a sender of a gift via an electronic display, the user interface being configured to allow the sender to create a media message; storing the media message in a database; associating the media message with a shipping status of the gift; verifying that the gift was delivered to a recipient of the gift; and delivering the media message to the recipient upon verification that the gift was delivered to the recipient.

In one embodiment, the user interface is provided to the sender as part of the checkout process of a retailer. In one embodiment, the media message is delivered to the recipient through the internet. In a further embodiment the method comprises the step of automatically generating a template for the media message based on previously provided information, the user modifying the template to create the media message. In a further embodiment the method comprises the step of delivering a message to the recipient on a predetermined date that the gift has been sent. In a further embodiment the method comprises the step of associating a passcode with the media message; providing the passcode to the recipient with the gift; and allowing the media message to be viewed only after the passcode has been entered.

In another embodiment there is a system comprising: one or more memory units each operable to store at least one program; and at least one processor communicatively coupled to the one or more memory units, in which the at least one program, when executed by the at least one processor, causes the at least one processor to: provide a user interface to a sender of a gift via an electronic display, the user interface being configured to allow the sender to create a media message; store the media message in a database; associate the media message with a shipping status of the gift; verify that the gift was delivered to a recipient of the gift; and deliver the media message to the recipient upon verification that the gift was delivered to the recipient.

### BRIEF DESCRIPTION OF THE SEVERAL VIEWS OF THE DRAWINGS

The following detailed description of embodiments of the systems and methods for delivering media messages, will be better understood when read in conjunction with the appended drawings of an exemplary embodiment. It should be understood, however, that the invention is not limited to the precise arrangements and instrumentalities shown.

In the drawings:

FIG. 1 is a screen shot of a media message in accordance with an exemplary embodiment of the present invention;

FIG. 2 is a block diagram of a system for delivering media messages in accordance with an exemplary embodiment of the present invention;

FIG. 3 is a flow diagram of the delivery of media messages in accordance with an exemplary embodiment of the present invention;

FIG. 4 is a flow diagram of user identification and media message review in accordance with an exemplary embodiment of the present invention;

FIG. 5 is a screen shot of a media message creation interface for an electronic greeting card in accordance with an exemplary embodiment of the present invention; and

FIG. 6 is a flow diagram of recording a video for a media message in accordance with an exemplary embodiment of the present invention.

### DETAILED DESCRIPTION OF THE INVENTION

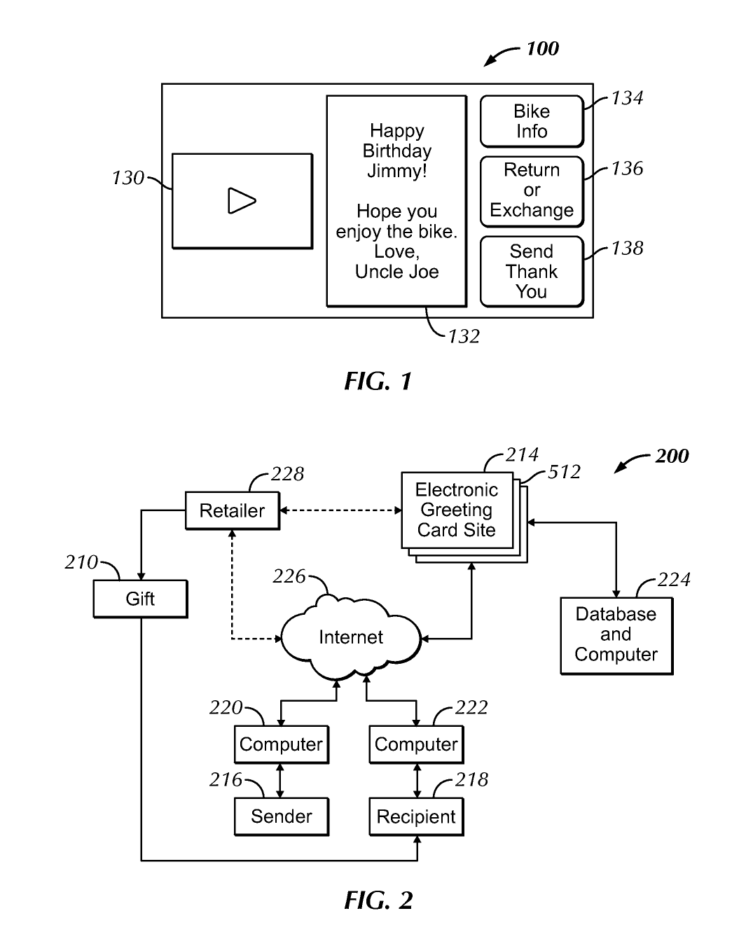

Referring to the drawings in detail, wherein like reference numerals indicate like elements throughout, there is shown in FIGS. 1-6, systems and methods for delivering media messages in accordance with exemplary embodiments of the present invention.

In some embodiments, the present invention provides a system and method for creating and delivering media messages (e.g., an electronic greeting card with a personalized video recording) to another person at either a predetermined time (e.g., on Jul. 4, 2015) or after an occurrence (e.g., a gift was delivered to recipient).

The phrase “media message” as used herein may include one or more of text, graphics, animation, audio, video, audio recording, video recording and embedded webpage links displayed on an electronic display. In some embodiments, the media message is completely user generated (e.g. a webcam recording of the user). In other embodiments, the media message is a combination of user generated or arranged content and preexisting content (e.g., a pre-existing digital video, such as a YouTube® video, dubbed over with the sender's own commentary) or completely preexisting content (e.g. only the pre-existing digital video). FIG. 1 illustrates an exemplary screen shot of a media message, generally designated 100.

In one embodiment, the present invention provides a system and method for creating and delivering media message 100 to a recipient in connecting with sending a gift to a recipient. In one embodiment, the sender purchases a gift and creates media message 100 to be sent to the recipient of the gift. In one embodiment, media message 100 is delivered to the recipient based on the shipping status of the gift. In one embodiment, media message 100 is delivered to the recipient of the gift at a predetermined time. In one embodiment, media message 100 is delivered to the recipient of the gift by the earliest of a predetermined time and a shipping status (e.g., media message 100 is delivered on Jul. 4, 2015 or upon delivery confirmation that the gift was delivered to the receipt, whichever occurs first). In one embodiment, the media messaging system or method is integrated into the checkout process of an online retailer. In other embodiments, the media messaging system or method is not affiliated with the retailer.

In one embodiment, the method or system is configured to allow and/or prompt a gift giver or sender to associate media message 100 with their gift in order to provide a timely and personalized message to the recipient. In one embodiment, the method or system is configured to allow and/or prompt the sender to associate media message 100 with their gift in order to provide additional information, through, for example, a hyperlink or widget, regarding the gift such as specification details. In one embodiment, the method or system is configured to allow and/or prompt the sender to associate media message 100 with their gift in order to help facilitate returns by, for example, providing access, such as a hyperlink or widget, to the retailer's return policy. In one embodiment, the method or system is configured to allow and/or prompt the sender to associate media message 100 with their gift in order to more easily share information about the gift with others (e.g., allows recipient to post the media message content and/or a picture of the gift on a social networking website such as Facebook®). In one embodiment, the method or system is configured to allow and/or prompt the sender to associate media message 100 with their gift in order to help facilitate a media conversation (e.g., after receiving a video message, the recipient may elect to send a reply video message to the sender).

In some embodiments, the method or system is configured to deliver media message 100 to a desired recipient or a portal viewable by a desired recipient at a predetermined time or after an occurrence in addition to or unrelated to gift giving. For example, it is common and socially acceptable on one's birthday to post greetings on their social networking website (e.g., a Facebook page or “wall”) effectively stating “Happy Birthday!” It is also common for the birthday person to thank everyone, via a status update in the evening of their birthday, for the well wishes. To avoid forgetting to post on a friend's page or thank everyone for their messages or if you are unavailable that day or time a media message may be created in advanced and automatically posted on the website at a specified date and time. Other embodiments for sending delayed media messages may include creating a media message that is displayed to loved ones after the sender's death. For example, someone with terminal cancer or a soldier going into a war zone may create a media message that is stored and automatically released if the intended recipient does not respond to a verification message after a certain date, after a predetermined date after which the sender know they will not be around or after a code is entered by the recipient that was left behind by the sender such as in a will.

In one embodiment, the method and system are configured such that one media message 100 is created by one person and delivered to one recipient. In one embodiment, the method and system are configured such that one media message 100 is created by one person and delivered to multiple recipients. In one embodiment, the method and system are configured such that one media message 100 is created by multiple people and delivered to one recipient. In one embodiment, the method and system are configured such that one media message 100 is created by multiple people and delivered to multiple recipients. In one embodiment, the method and system are configured such that multiple media messages 100 are created by one person and delivered to one recipient. In one embodiment, the method and system are configured such that multiple media messages 100 are created by one person and delivered to multiple recipients. In one embodiment, the method and system are configured such that multiple media messages 100 are created by multiple people and delivered to one recipient. In one embodiment, the method and system are configured such that multiple media messages 100 are created by multiple people and delivered to multiple recipients.

Referring to FIGS. 1-3, in one embodiment, the method or system is configured to allow and/or prompt a user, gift giver or sender 216 to create media message 100 using an interface 512 (see FIG. 5) on an electronic greeting card portal or site 214 to be delivered to one or more receivers or recipients 218 in connection with an event such as the delivery of a gift 210. In one embodiment, the delivery of an item and the delivery of a message associated with the item are coordinated in time. For example, the method or system is configured to allow gift 210 to be delivered to a recipient 218 at a predetermined time after media message 100 has been delivered to the recipient 218. In another example, the delivery of gift 210 to a recipient 218 will trigger the delivery of media message 100 to the recipient 218. In one embodiment, the method and system are configured such that media message 100 is viewable by recipient 218 only after the recipient 218 has entered a passcode as described in further detail below.

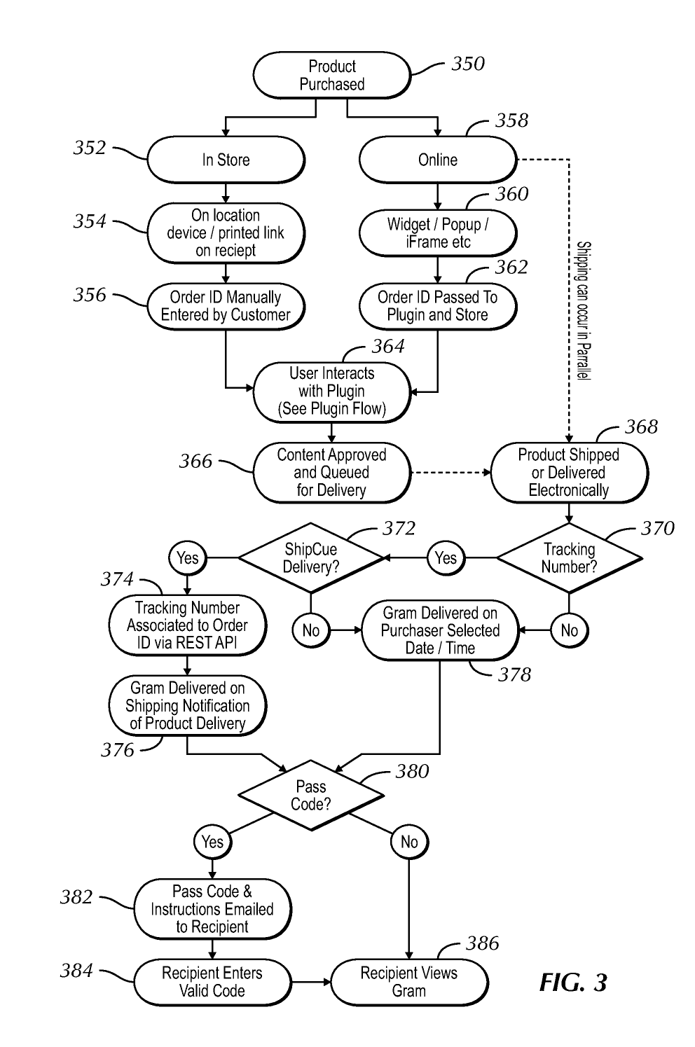

Referring to FIG. 2, a block diagram of an exemplary embodiment of a system and method for creating and delivering media messages, generally designated system 200, is shown. In one embodiment, system 200 includes an electronic greeting card site 214, a retailer store or website 228, a sender 216 or sender portal, and a recipient 218 or recipient portal. In one embodiment, respective computers 220, 222 (such as desktops, tablets, smart phones, voice and/or motion detection software, or smart televisions) interface sender 216 and recipient 218 to the Internet 226 or other wide area network such that sender 216 or recipient 218 can interact with electronic greeting card site 214.

In one embodiment, electronic greeting card site 214 is a website or series of websites on Internet 226 and may include servers and other computers 224 as is well known in the art. In some embodiments, electronic greeting card site 214 includes a smart phone or television application or “app”. In some embodiments, sender 214 points their browser to electronic greeting card site 214 or opens the app to create media message 100 to send to recipient 218.

In one embodiment, electronic greeting card site 214 includes servers and other computers 224 to implement its functionality. Other embodiments may have any number of affiliated websites that may or may not be affiliated with system 200. In some embodiments, affiliated websites, such as the retailer's 228 website, allow for creation of media message 100. In some embodiments, websites not affiliated with retailer 228 are used to create media message 100. In such embodiments, sender 216 may manually identify gift 210 and provide or link the gift delivery status information to media message 100.

Referring to FIG. 1, in one embodiment, media message 10 includes one or more messages or information to be sent to recipient 218. In one embodiment, media message 100 includes a video 130. In one embodiment, video 130 is uploaded into the browser by sender 214. In one embodiment, video 130 is uploaded to a third party host such as YouTube® or Vimeo® which is then linked to or embedded into media message 100. In one embodiment, media message 10 is stored as a flash file. In other embodiments, media message 100 is stored as an MP4, MPEG or any other desirable format.

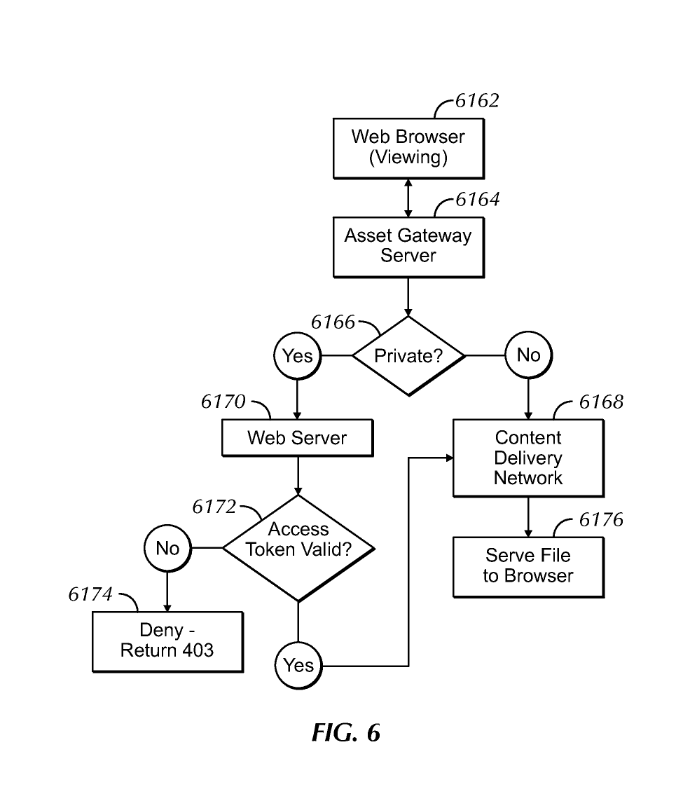

Referring to FIG. 6, in one embodiment, at step 6166, sender 216 may set video 130 as private. In one embodiment, if set to private, the file is also set to private on the content delivery network (CDN) using the built in permissions. In one embodiment, at step 6162, to view video 130, the recipient's browser will send a request to a web server, at step 6164, which is a gateway to accessing private videos. In one embodiment, if video 130 is private, a unique access token must be generated by using a representational state transfer application program interface (“REST API”) and appended to the request for the file. In one embodiment, as the gateway receives a request for a file, it connects to the web server to check if the file is public or private and if the access token is valid.

In one embodiment, if video 130 is marked as public, or the access token is valid for the private video, the gateway server redirects the request to the CDN at step 6168 to deliver the file at step 6176. In one embodiment, video 130 files that are marked as private are set to private on the CDN as well, using built in permissions, thereby disabling public access by attempting to access the file on the CDN directly.

In one embodiment, at step 6170, the web server generates a unique connection token and stores it memory and passes the token to the sender's browser. In one embodiment, at step 6172 an access token is generated via REST API call. In one embodiment, the token is appended to the URL of the media file (e.g., ?access_token= . . . ). In one embodiment, the request is routed to a ‘gateway’ which validates the token (if the video is private). If valid, the request is redirected to S3 appending the special key & secret credentials to the request to allow access of the private content. If invalid, an HTTP Status of 403 “Forbidden” S3 is returned at step 6174.

In one embodiment, on confirmation from sender, at step 6168 and 6176, video 130 is published by uploading to a CDN.

In one embodiment, sender's browser loads the recorder in their client and sets the unique token in configuration settings. In one embodiment, the recorder attempts to connect to a server such as a Flash Media Server (FMS). In one embodiment, the server will send a request to the web server to validate the token and accept the connection if it is valid. In one embodiment, when sender 216 has completed the recording process, the client will flush its buffer of video 130 to the server. In one embodiment, the server will encode video 130 into a file format (e.g., a flash video file (.flv), MP4 o MPEG) and expose video 130 to be reviewed by sender 216.

Referring to FIG. 1, in one embodiment, media message 100 includes a text message or greeting 132. In one embodiment, the method or system is configured to allow greeting 132 to be completely inputted by sender 216 (e.g., by recording a message in response to a prompt or by upload a pre-recorded message). In one embodiment, the method or system is configured to allow greeting 132 to be selected from a plurality of pre-generated messages. In one embodiment, the method or system is configured to allow greeting 132 to be automatically populated based on previously provided information. For example, if sender 216 selects a birthday theme and purchased a bike, the message “Happy Birthday ______! I hope you enjoy the BMX Series 2 Bicycle—Red. From Joe Smith.” may be automatically generated, or may be automatically generated upon request by sender 216, based on the saved or known information. In one embodiment, the method or system is configured to allow sender 216 to edit the automatically generated greeting. For example, the message above could be revised by sender 216 after it is generated to say “Happy Birthday Jimmy! I hope you enjoy the bike. Love, Uncle Joe”.

In one embodiment, media message 100 displays all of the messages to recipient 218 at once. In one embodiment, media message 100 includes is a series of two or more successive messages. For example, a first screen displays video 130 and audio of sender 216 singing happy birthday and once video 130 is complete a second screen or portion of the first screen displays greeting 132 “Happy Birthday Jimmy!”. In one embodiment, the successive messages are in the same location on the electronic display. In other embodiments, the successive messages are offset on the electronic display from where the other messages appeared.

Referring to FIG. 1, in one embodiment, media message 100 includes or is associated with an access button or area 134, such as a hyperlink or widget, to direct recipient 218 to information on gift 210. For example, if gift 210 is a bicycle, access area 134 could include a hyperlink that directs recipient 218 to content related to gift 210 such as the gift manufacture's website. In one embodiment, media message 100 is displayed in association with an access button or area 136, such as a hyperlink or widget, to direct recipient 218 to return or exchange information for gift 210. In one embodiment, access area 136 directs recipient 218 to retailer's 228 website. In one embodiment, access area 136 directs recipient 218 to a website regarding recipient's 218 specific order. For example, if recipient 218 wants a blue bicycle rather than a red bicycle, recipient 218 can click on access area 136 that directs recipient 218 to their order details and allows recipient 218 to print a return address label and select the new bicycle that will ship upon receipt of the original bicycle.

In one embodiment, media message 100 includes an access area 138, such as a hyperlink or widget, to direct recipient 218 to generate a reply media message 100 to be sent to sender 216. For example, if sender 216 included a video in media message 100, recipient 218 may choose to send a reply video in a media message, similar to media message 100, expressing their thanks for media message 100 and gift from sender 216. In one embodiment, access area 138 links recipient 218 to sender's social networking page to post a thank you on sender's 216 social networking page.

In one embodiment, information regarding gift 210 being sent determines what messages or options for messages are available. For example, if returns of gift 210 are permitted, access area 136 for return information is provided. In one embodiment, the method or system is configured to allow sender 216 to determine what media messages or options are included in media message 100. For example, even if returns are permitted, sender 216 may elect to leave out access area 136 for return information.

Referring to FIG. 3, in one embodiment, sender 216 purchases gift 210 from a retailer 228 either online or at a physical store at steps 350, 352, 358. In one embodiment, gift 210 is shipped after the purchase at steps 368, 370 but before sender 216 generates media message 100. In one embodiment, shipping of gift 210 and creation of media message 100 are done in parallel to avoid delaying shipment. In other embodiments, gift 210 is shipped after media message 100 is created at step 366. In one embodiment, a passcode, QR code, or order number is printed on a packing slip included by retailer 228 in the box containing gift 210.

In one embodiment, at step 358 sender 216 purchases gift 210 online. In one embodiment, at steps 360, 362 electronic greeting card site 214 is presented to sender 216 by retailer 228. In one embodiment, system 200 is integrated into retailer's 228 website. In one embodiment, retailer 228 or a portal associated with retailer 228 directs sender 216 or recommends that sender 216 use system 200 provided by a third party through a different website. In one embodiment, gift 210 is a digital product that is delivered via electronic delivery with media message 100. In other embodiments, gift 210 is a physical item that is physically delivered to recipient 218.

In one embodiment, at steps 368, 370 gift 210 is shipped by retailer 228 via a shipping service and a tracking number or other reference affiliated with the shipping status of gift 210 is provided. In one embodiment, at step 352 sender purchases gift 210 in retailer's 228 store and in step 354 a reference to system 200, such as a URL, is printed on the receipt. In one embodiment, at step 356, sender 216 accesses system 200 and enters in information regarding the purchase of gift 210 such as an order reference number. In one embodiment, at step 364, the method or system is configured to allow recipient 218 to interact with a plugin to create media message 100. In one embodiment, at steps 368, 370, gift 210 is shipped by sender 216 and tracking or reference number is generated and manually entered into system 200. In one embodiment, at step 354 sender 216 purchases gift 210 in retailer's 228 store and is directed to an in store device (e.g., a webcam, a smart phone, a tablet or a desk top computer) to create media message 100 or at least some of the content for media message 100. In one embodiment, retailer 228 records a video of sender 216 directed to recipient 218 and retailer 228 sends sender 216 a message such as an e-mail with a hyperlink to electronic greeting card site 214. In one embodiment, at checkout, sender 216 provides retailer with contact information such as a phone number or e-mail address and retailer 228 sends a message to sender 216 with information regarding creating media message 100.

In one embodiment, at step 370 if no tracking reference is associated with media message 100, media message 100 (also referred to as video or “Gram” in the drawings) may be delivered at step 378 to recipient 218 on a specified date and time. In one embodiment, the method or system is configured to allow media message 100 to be delivered to recipient 218 on a specified date and time even if a tracking reference is associated with media message 100 in the event gift 210 takes longer than sender 216 had anticipated. For example, if recipient's 218 birthday is next Friday, sender 216 may want media message 100 to be delivered on Friday even if gift 210 has not yet arrived. In one embodiment, system 200 is notified whether recipient 218 has viewed media message 100. In one embodiment, if recipient 218 has received media message 100 at the specified date prior to confirmation that recipient 218 received gift 210 and media message 100 has not yet been viewed by recipient 218, media message 100 may be resent upon confirmation that gift 210 was received.

In one embodiment, at step 372, access to media message 100 is validated. In one embodiment, at step 374, the tracking reference affiliated with gift 210 is associated to an order identification number affiliated with media message 100. In one embodiment, at step 376 media message 100 is delivered upon verifying that gift 210 was delivered to recipient 218. In one embodiment, the tracking reference is used to verify delivery of gift 210. In one embodiment, the tracking reference affiliated with gift 210 is associated to media message 100 via REST API.

In one embodiment, the method or system is configured to allow delivery of gift 210 to be verified using the tracking information. In one embodiment, the method or system is configured to allow delivery of gift 210 to be verified automatically using the tracking information. In one embodiment, the method or system is configured to allow delivery of gift 210 to be verified using the tracking information without any human input. In one embodiment, the method or system is configured to allow delivery of gift 210 to be verified using the tracking information without input or action from sender 216 or recipient 218. In one embodiment, the method or system is configured to allow delivery verification of gift 210 using the tracking reference occurs by system 200 pinging the shipper's application programming interface, checking the status of the specified Shipping Tracking Number and initiating a message delivery upon confirmation of a ‘delivered’ response from the shipping service. In one embodiment, the method or system is configured to allow the shipping service to notify system 200 that gift 210 was delivered.

In one embodiment, the method or system is configured to allow sender 216 to verify delivery of gift 210. In one embodiment, the shipping service sends one or more messages to sender 216 and then sender 216 verifies with system 200 that gift 210 was delivered. In one embodiment, sender 216 monitors the delivery status and verifies with system 200 when gift 210 has been delivered. In one embodiment, sender 216 is notified by recipient 218 or someone who knows recipient 218 (e.g., a postal worker, relative, roommate or doorman) that gift 210 has been delivered so that sender 216 can verify with system 200 that gift 210 has been delivered. In one embodiment, sender 216 requests system 200 to send a message to a third party to verify deliver. For example, sender 216 may instruct system 200 to send a message to recipient's mother “I'm sending a package to Jimmy for his birthday. Please do me a favor and click here when the package has arrived”.

In one embodiment, the method or system is configured to allow recipient 218 to directly or indirectly verify delivery of gift 210. In one embodiment, delivery of gift 210 is verified upon the recipient 218 responding or accessing the information associated with the delivered gift 210. In one embodiment, a short link, QR code, or passcode associated with gift 210 is printed by retailer 228 on the original packing slip for gift 210 that is delivered to recipient 218. In one embodiment, the link, QR code or passcode can be included on the packaging of gift 210 with an instructional message such as “Scan here for a message from Uncle Joe”. In one embodiment, the method or system is configured to allow a message such as an e-mail or text to be sent to recipient 218 in advance of delivery of gift 210 to verify when they are in receipt of gift 210 (e.g., “Expect a package soon from Uncle Joe. Click here as soon as the package arrives for a special message.”).

In one embodiment, the method or system is configured to allow media message 100 or a notification of the availability of media message 100 to be delivered to recipient 218 in any electronic format including e-mail, text, app, social media or pushed to an electronic device such as a tablet, television or home security system. In one embodiment, at step 380 media message may include a passcode in order to access media message 100. In one embodiment, if a passcode is required, at step 382 recipient 218 receives instructions for retrieving media message 100. In some embodiments, the passcode may be a login used to access electronic greeting card site 214. In one embodiment, the passcode is associated with gift 210 such as the last 4 digits of the order identification number. In some embodiments, at step 384 recipient 218 enters in the passcode into system 200 to access media message 100. In one embodiment, at step 386 recipient 218 views media message 100.

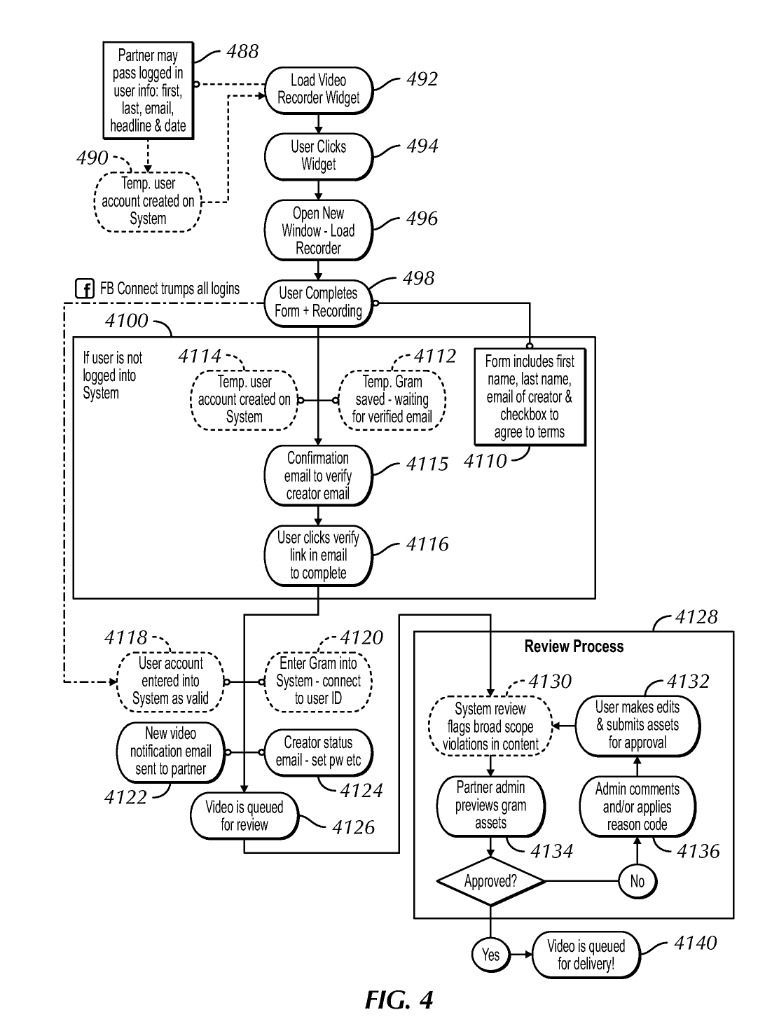

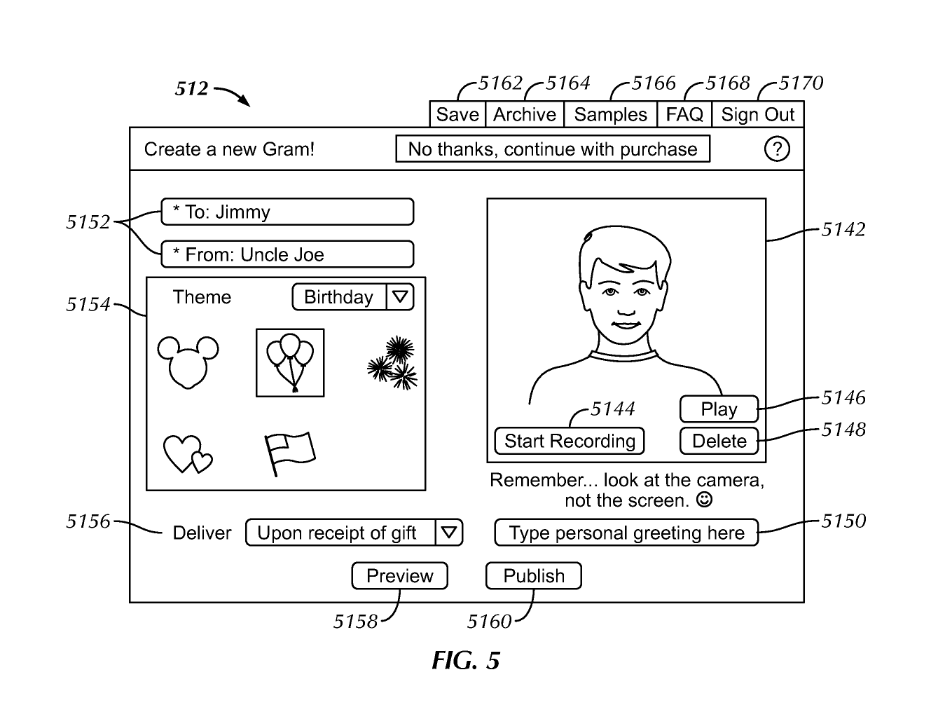

Sender 216 may log into electronic greeting card site 214 in a number of ways. In one embodiment, retailer 228 may be partnered with electronic greeting card site 214 and configured to allow for automatic access to electronic greeting card site 214. Referring to FIG. 4, in one embodiment, at step 488 retailer 228 may pass through the logged in user information (e.g., name, e-mail, headline and date). In one embodiment, at step 490, a temporary user account is created for accessing electronic greeting card site 214. In one embodiment, at step 492 electronic greeting card site 214, such as a widget, app or webpage, is loaded. In one embodiment, at step 494, sender 216 opens electronic greeting card site 214. In one embodiment, at step 496, a new window or at least a portion of the screen displays interface 512 (see FIG. 5). In one embodiment, at step 498, sender 216 completes forms and recording of video to create media message 100.

Referring to FIG. 5, in one embodiment, interface 512 is used by sender 216 to create media message 100. In other embodiments, the method or system is configured to allow media message 100 to be created by a succession of prompts requesting information. In other embodiments, the method or system is configured to allow media message 100 to be created with the assistance of someone from retailer 228. For example, the cashier at retailer 228 may ask a customer if the purchase is a gift and whether the customer would they like to send a video message. If they the customer says “yes” and “yes I would”, the cashier can direct the customer to look into a nearby camera or have the customer walk over to a camera set off to the side having a green screen or prefabricated backdrop. Once the video has been recorded, the cashier can help the customer fill in any remaining information for media message 100 or present the customer with a screen to have them input any information and/or view media message 100.

In one embodiment, interface 512 includes one or more areas, drop down menus, and check boxes to create personalized content to be included in media message 100. In one embodiment, sender 216 creates media message 100 by inputting and/or recording information into interface 512. In one embodiment, interface 512 is automatically presented to sender 216 after they indicate that the item they purchased from retailer 228 is a gift. In other embodiments, interface 512 is accessed independent of retailer 228. In one embodiment, the method or system is configured to allow video window 5142 to be provided to watch what sender 216 recorded. In one embodiment, video window 5142 shows sender 216 creating the video in real time as the video is being recorded. In one embodiment, the method or system is configured to allow a record button 5144 to be provided that sender 216 selects to start the recording. In one embodiment, the method or system is configured to allow record button 5144 to be selected again to stop recording. In one embodiment, the method or system is configured to allow record button 5144 to change its label that is visible to sender 216 depending on what options are available. For example, prior to recording, record button 5144 may be labeled “Start Recording” but once recorded has started it may be changed to “Stop Recording”. In one embodiment, additional buttons or options may be provided to view and edit the recorded video. In one embodiment, the method or system is configured to allow a play 5146 and/or a delete 5148 buttons to be available after a video has been recorded.

In one embodiment, the method or system is configured to allow a text field 5150 to be provided to allow sender 216 to type a greeting such as greeting 132 (see FIG. 1). In one embodiment, the method or system is configured to allow additional text fields 5152, 5154 to be provided to input additional information such as names that may be used in media message 100 or in relation to media message 100 such as in the notifications that media message 100 is available. For example, inputted names could be used in the subject and body of an e-mail sent to recipient 218 to notify them that they have a new media message 100. In one embodiment, the method or system is configured to allow a selection of themes 5154 for media message 100. In on embodiment, the selection of a theme 5154 by the user alters one or more of the color, graphics, layout and design of media message 100.

In one embodiment, a delivery selection 5156 is provided. In one embodiment, delivery selection 5156 allows sender 216 to choose when media message is delivered. If not already affiliated with gift 210, in the case of interface 512 being presented to sender 216 by retailer as part of the check out procedure, a field may be provided to ender in the tracking information for a gift 210.

In one embodiment, the method or system is configured to allow a preview button 5158 to be provided such that, when selected, sender 216 is permitted to view media message 100 as it would be presented to recipient 218. In one embodiment, the method or system is configured to allow a save button 5162 to be provided to save a draft of media message 100. In one embodiment, the method or system is configured to allow an archive button 5164 to be provided to allow access to other media messages 100 that sender 216 drafted or sent while logged into their account. In one embodiment, the method or system is configured to allow a previously sent media message 100 to be used as a template to create a new media message 100. For example, if a user has five nephews, he may create one video in a media message 100 for the first nephew and then use the same video and essentially the same text and options to create the media messages 100 for the remaining nephews.

In one embodiment, the method or system is configured to allow sender 216 to invite or notify people, including or other than recipient 218, to record a video/audio message (e.g., to associate the message with a purchased item).

In one embodiment, the method or system is configured to allow a samples button 5166 to be provided to show examples of how create a media message. In one embodiment, samples button 5166 includes one or more templates that can be used to create a new media message 100.

In one embodiment, the method or system is configured to allow a FAQ button 5168 to be provided to help answer frequently asked questions of how to use interface 512. In one embodiment, the method or system is configured to allow a sign out button 5170 to be provided to allow sender 216 to sign out of system 200.

In one embodiment, after sender 216 is finished creating media message 100, the method or system is configured to allow a publish button 5160 to be selected. In one embodiment, publishing media message 100 completes the media message 100 creation.

Referring again to FIG. 4, in one embodiment, at step 4100, if sender 216 is not logged onto system 200 or a partner site such as an affiliated retailer 228 a form 4110 may be generated that includes information of sender 216 such as name, e-mail and whether they have agreed to terms of using electronic greeting card site 214. In one embodiment, at steps 4114 and 4112 a temporary user account is created for electronic greeting card site 214 and a temporary media message 100 is saved. In one embodiment, at step 4115 a confirmation e-mail is sent to sender 216 to verify creator of the account. In one embodiment, at step 4116, sender 216 uses the information in the e-mail, such as by clicking on an embedded hyperlink, to complete verification of their account. In some embodiments, sender 216 can create an account with electronic greeting card site 214 prior to creating media message 100. In other embodiments, a single sign-on (SSO), such as a social network login (e.g., Facebook Connect®) may be used to create a user account or allow access as a registered user to electronic greeting card site 214.

In one embodiment, at step 4118, sender's 216 account is entered into database 224 as being valid. In one embodiment, at step 4120, if media message 100 is created before account was validated, media message 100 is associated with sender's 216 account. In one embodiment, at step 4122, a message or reference is sent to retailer 228 regarding media message 100. In one embodiment, retailer 228 can include this reference in correspondence with sender 216 and/or recipient 218. In one embodiment, step 4122 represents a notification to retailer 228 or third party software licensee that a video has been recorded so they know when to log into their administrative area to review media message 100 for content/policy infractions before the system queues media message 100 to be sent based on the predetermined shipping rules for media message 100. In one embodiment, at step 4124, a message such as an e-mail is sent to sender 216 regarding their new account. In one embodiment, at step 4126, media message 100 is queued for review.

In one embodiment, at step 4128, media message 100 is reviewed by electronic greeting card site 214 and/or retailer 228. In one embodiment, at step 4130, electronic greeting card site 214 administrators review media message 100 for inappropriate or potentially illegal content. In one embodiment, system 200 automatically reviews media message 100 for copyrighted content. In one embodiment, audio is extracted from media message 100 and automatically translated into text. In one embodiment, the translated text is then queried against a pre-defined list of ‘unacceptable’ or flagged words. In one embodiment, if there a flagged word, media message 100 will go into a manual queue where an administrator will determine to approve, reject, or request sender 216 to edit before video delivery. In one embodiment, the method or system is configured to allow video 130 from media message 100 to be captured as a series of images (e.g., screen shots are recorded at 1 ,3, or 5 second intervals) and displayed visually for either a) manual review or b) Optical Character Recognition technology to ensure that there is no copyrighted or trademarked material in view. For example, sender 216 may be wearing a ‘Nike’® branded shirt which would be flagged for review.

In one embodiment, the method or system is configured to allow a person to review media message 100 for compliance. In one embodiment, at step 4134, retailer 228 or other partner review media message 100 for compliance. In one embodiment, at step 4136, administrators comment on the reason for rejection. In one embodiment, at step 4132, sender 216 is given the option to edit media message 100 and resubmit for approval. In one embodiment, at step 4140, once the review process is complete, media message 100 is queued for delivery to recipient 218.

In one embodiment, the invention includes one or more computers having one or more processors and memory (e.g., one or more nonvolatile storage devices). In some embodiments, memory or computer readable storage medium of memory stores programs, modules and data structures, or a subset thereof for a processor to control and run the various systems and methods disclosed herein. In one embodiment, a non-transitory computer readable storage medium has stored thereon computer-executable instructions which, when executed by a processor, perform one or more of the methods described above. In one embodiment, a system includes one or more memory units each operable to store at least one program; and at least one processor communicatively coupled to the one or more memory units, in which the at least one program, when executed by the at least one processor, causes the at least one processor to perform one or more of the methods described above.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

It is also to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

I/we claim:

1. A method comprising:
providing a user interface to a sender of a gift via an electronic display, the user interface being configured to allow the sender to create a media message;
storing the media message in a database;
associating the media message with a shipping status of the gift;
verifying that the gift was delivered to a recipient of the gift; and
delivering the media message to the recipient upon verification that the gift was delivered to the recipient.

2. The method of claim 1, wherein the user interface is provided to the sender as part of the checkout process of a retailer.

3. The method of claim 1, wherein the media message is delivered to the recipient through the internet.

4. The method of claim 1 further comprising:
automatically generating a template for the media message based on previously provided information, the user modifying the template to create the media message.

5. The method of claim 1 further comprising:
delivering a message to the recipient on a predetermined date that the gift has been sent.

6. The method of claim 1 further comprising:
associating a passcode with the media message;
providing the passcode to the recipient with the gift; and
allowing the media message to be viewed only after the passcode has been entered.

7. A system comprising:
one or more memory units each operable to store at least one program; and
at least one processor communicatively coupled to the one or more memory units, in which the at least one program, when executed by the at least one processor, causes the at least one processor to:
provide a user interface to a sender of a gift via an electronic display, the user interface being configured to allow the sender to create a media message;
store the media message in a database;
associate the media message with a shipping status of the gift;
verify that the gift was delivered to a recipient of the gift; and
deliver the media message to the recipient upon verification that the gift was delivered to the recipient.
